(19) United States
(12) Patent Application Publication
(10) Pub. No.: US 2016/0374316 A1
(43) Pub. Date: Dec. 29, 2016

(54) Aerodynamic Treat For A Pet, and Dispenser For Dispensing An Aerodynamic Pet Treat

(71) Applicant: Radio Systems Corporation, Knoxville, TN (US)

(72) Inventors: Christopher E. Mainini, Knoxville, TN (US); Anita White, Knoxville, TN (US); Daniel Norwood, Knoxville, TN (US); Kristine Jansen, Knoxville, TN (US); William S. Groh, Knoxville, TN (US)

(21) Appl. No.: 15/189,377

(22) Filed: Jun. 22, 2016

Related U.S. Application Data
(60) Provisional application No. 62/184,943, filed on Jun. 26, 2015.

(51) Int. Cl. A01K 15/02; G06F 3/16; G06F 3/01; A01K 5/02; G08C 17/02

(52) U.S. Cl. CPC A01K 15/026; A01K 5/0291; A01K 5/0225; G08C 17/02; G06F 3/017; G06F 3/167

(57) ABSTRACT

A novel pet treat is provided. The pet treat defines a multi-dimensional object that is edible. The pet treat has a profile that provides enhanced aerodynamic properties when it is dropped, flicked, thrown or released. A method for dispensing an animal treat is also provided wherein the pet treat is mechanically dispensed by locally actuating a dispenser, or by automated dispensing based on motion of the pet, or a timer, or by remote control with the use of a personal computer or a wireless communications device having appropriate software or firmware downloaded. The pet owner or authorized user may command the dispenser to actuate or dispense a pet treat at any time. Automated motion event and timer based actuations are preferably enabled when the pet is alone or the pet treat dispenser is unattended.

### CROSS REFERENCE TO RELATED APPLICATIONS

This application claims the benefit of U.S. Provisional Patent Application No. 62/184,943 filed Jun. 26, 2015. That application is entitled “Aerodynamic Pet Treat, and Dispenser for Dispensing Aerodynamic Pet Treats,” and is incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Field of the Invention

The present inventive concept relates to the field of animal treats. More particularly, the invention relates to edible toys for a pet, wherein the edible toys have aerodynamic properties. The invention further relates to dispensing mechanisms that facilitate the release, aerodynamic delivery, or launch of treats to a pet at random or specific times or frequencies as controlled by an owner.

Technology in the Field of the Invention

For a healthy environment, household pets desire and need physical and mental variety and randomness in their lifestyle. One way to provide randomness is to occasionally offer and hand deliver the pet treat. Both dogs and cats love treats and respond with love and playfulness when the treat is provided. Furthermore, treats facilitate a trust and bonding between a pet and its owner. Treats can also serve a useful role in the training of a pet by providing positive reinforcement and encouragement for good behavior.

Another way to provide personal bonding with and entertainment for a pet is through the interaction with pet toys. However, pet toys are different from pet treats and play an independent part in the lives of pets and their owners. Historically, treats and toys have been two separate product categories which are marketed, sold and used in different manners.

Typically, pet treats themselves have provided minimal entertainment for pets due to the shapes, sizes and the delivery methods; either inactively laying around for the taking, being handed directly to the pet's mouth, or by being thrown to simulate a pet toy. Pet owners may leave toys at home for the pets, but pets generally do not play with toys when they are left alone, and do not receive the same validation and confirmation as they do from treats. These same limitations exist for automated or remotely controlled pet food dispensing systems.

Pet treats make up a sizable portion of the approximately $22B spent on pet food of the much larger total pet market. There appears to be an opportunity to satisfy the needs of pets and their owners by providing nutrition and enrichment for pets through a modification of the pet treat to provide entertainment and stimulation for a pet. This need is further increased today based on more pets being left alone at home than ever before, causing pets to have separation anxiety and causing their owners to feel guilty with regard to these circumstances.

Accordingly, a need exists for a treat that may be used as a toy, effectively creating an edible play item. A need further exists for a treat that may be dispensed or provided from a locally attended, unattended, or remotely actuated dispensing mechanism wherein the treat has entertainment values in the form of aerodynamic properties so that the treat glides, levitates, wobbles, spins or floats through the air upon dispensing, thus extending flight time and flight distance. A need further exists for a pet treat that has bouncing or rolling characteristics in unpredictable or erratic patterns to further entice the pet. A need further exists, in some aspects, for such a treat that is low in calories and is nutritionally wholesome.

### BRIEF SUMMARY OF THE INVENTION

A pet treat is first provided herein. The pet treat defines a multi-dimensional object having enhanced aerodynamic properties. The treat may be in the shape of a maple seed, an airplane or other object having a wing, airfoil or other aerodynamic shape.

In another embodiment, the pet treat is fabricated from an edible, elastomeric material. The treat defines a multi-dimensional object that has an oblong, eccentric or random external surface. When dropped, the treat bounces or rolls in an erratic manner, thereby creating interest and entertainment for both pet and its owner.

A method for providing a treat is also disclosed herein. In accordance with the method, a pet owner receives or is provided with a generally planar pet treat material. In one aspect, the pet treat material is actually rolled or extruded by the pet owner from a mass of material into planar form. The pet owner then optionally cuts the rolled material into an initial flat shape for folding, and thereafter folds the pet treat material by following a series of folding steps. The end result is that a pet treat having aerodynamic properties which are created through an origamic configuration.

Alternatively, pet treats may be formed by pressing the planar material against a three-dimensional form such as a hemispherical, semi-ellipsoid, or rectangular mold. The pet owner trims the overlapped material at the edges resulting in two hollow shell halves. The shell halves can then be optionally loaded with smaller edible treats and then coupled together to form a complete enclosed shell.

A method for dispensing a treat is also offered herein. In accordance with the method, a pet owner places pre-formed pet treats into a dispensing mechanism. The mechanism may be mechanically actuated, such as by pressing a button or rotating a handle. Alternatively, the dispensing mechanism may be remotely controlled through the use of a control unit, such as a tablet or a so-called smart phone. Alternatively still, the dispensing mechanism may be actuated according to a timer set by the owner or the manufacturer, or according to an event, such as a dog bark or the detection of motion. The event/timer controlled and remotely controlled modes of the dispensing mechanism mitigate separation anxiety when the pet owner is away, and provides healthful exercise for the pet.

In any aspect, after moving a pet treat to a release position using a transferring mechanism, the dispensing mechanism releases the pet treats in such a way that the pet treats are singly or multiply released or launched. The treats travel in an aerodynamically enhanced manner to a lower surface such as the ground or floor. The falling time of the pet treat to the ground is extended while the pet treat glides or floats through the air. Alternatively, the treat is fabricated from an elastomeric material and formed with an irregular external surface that causes the treat to bounce in an erratic manner.

In another method for delivering a pet treat, a pet owner manually flicks, drops or throws the pet treat in such a way that the pet treat levitates, glides, or floats before slowly landing on a lower surface, such as the ground or floor. The pet treat again has an enhanced aerodynamic property. The enhanced aerodynamic provide entertainment and interest for both the pet owner and his/her pet.

In one embodiment for a method for dispensing a treat, a programmable pet treat dispenser is employed. The pet treat dispenser may be a modified pet feeding device wherein the bowl that would otherwise receive pet food is removed. The step would then include placing the treat dispenser at an elevated location so that when the dispenser is activated, a pet treat having aerodynamic properties is released. Preferably, the treat dispenser is programmed through a unique voice recognition technology.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1A is a perspective view of a maple seed. This is a naturally occurring object spawned from maple trees. The maple seed has well-known aerodynamic properties that cause it to rotate rapidly when falling, thereby creating lift which slows its descent.

FIG. 1B is a perspective view of an origami-formed version of a maple seed. The design is intended to duplicate the known aerodynamic properties of the natural maple seed.

FIG. 2A is a perspective view of an origami-formed object having an aerodynamic shape. This object is also designed to rotate rapidly when falling, thereby creating lift which slows its descent.

FIG. 2B a perspective view of an origami-formed object having an aerodynamic shape. Here, the shape is that of an airplane. This shape includes aerodynamic properties designed to allow the object to glide through the air.

FIG. 3 is an exploded view of a hollow spherical shell-shaped pet treat.

FIG. 4 is a plan view of an object that is designed to float, or slowly fall, when launched or dispensed off of an elevated surface.

FIG. 5A through 5H are a series of figures which illustrate a series of folding steps starting with a rectangular planar piece of pet treat material and ending with an aerodynamic pet treat.

FIG. 6 is a schematic view of a portion of a dispensing mechanism, in one embodiment, wherein the dispensing mechanism is in the form of a carousel with ribs forming chambers for holding a plurality of pet treats.

FIG. 7 is a schematic view of a portion of a dispensing mechanism, in another embodiment, wherein the dispensing mechanism uses a motor arm to dispense a stacked arrangement of pet treats.

FIG. 8 is a schematic view of a portion of a dispensing mechanism in yet another embodiment, wherein the dispensing mechanism uses a gravitational funnel to dispense a plurality of pet treats.

FIG. 9 is a schematic diagram of components of a pet treat dispensing system which include programmable capabilities for dispensing a treat.

FIG. 10A is a schematic view of a programmable pet feeding device of the present invention which includes a microphone that receives speech commands from a user.

FIG. 10B is a schematic view of a pet feeding device of the present invention, in another embodiment, which includes the options of a microphone that receives speech commands from a user remotely, a cloud based component, and a personal handheld computing device.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

In the present disclosure, the terms “levitate” or “float” do not imply that the laws of gravity are violated; rather, these terms describe a circumstance where a pet treat falls to a lower surface at a slower rate due to air resistance or due to the presence of an airfoil or wing, by virtue of an aerodynamic design.

### Description of Selected Specific Embodiments

A pet treat is first provided herein. In one embodiment, the pet treat defines a multi-dimensional object that has aerodynamic properties. The aerodynamic property may be, for example, an airfoil or wing and a body which is extremely light weight or which has an uneven weight distribution.

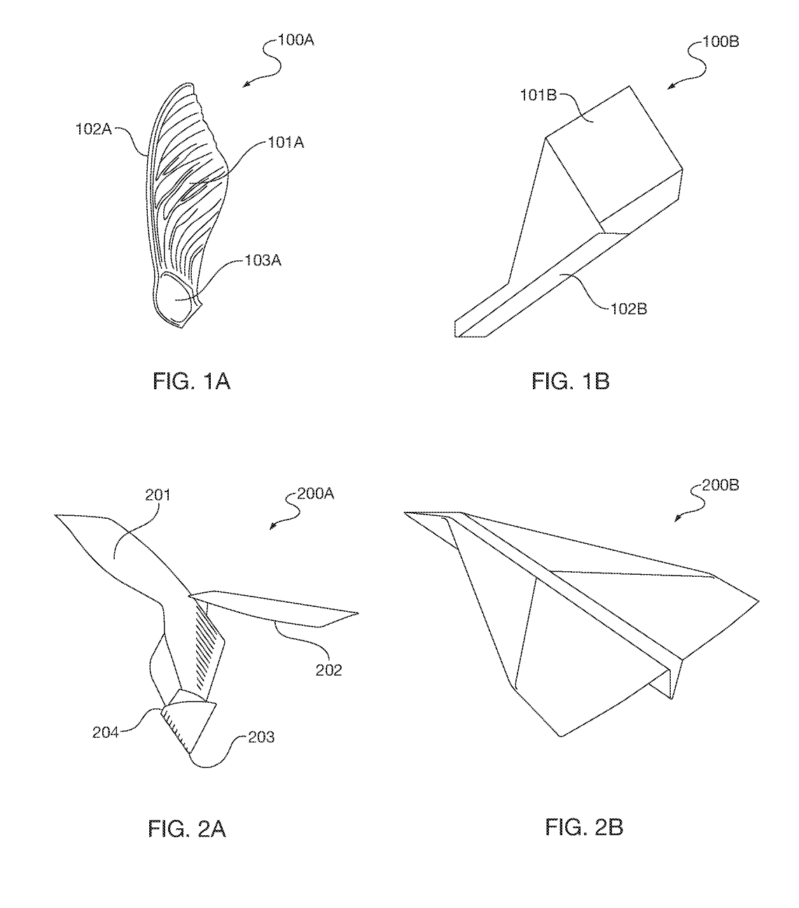

FIG. 1A is a naturally occurring maple seed 100A. The natural maple seed has well-known aerodynamic properties that cause it to spin or rotate rapidly when falling from the tree to the ground. The aerodynamic properties causes it to float during its descent to the ground. The natural construction of the maple seed 100A includes an air foil or wing 101A. The maple seed 100A also has a leading edge shaft or concentration of veins 102A, and a seed nodule 103A. The maple seed 100A has an uneven weight distribution, with most of the weight being at the seed nodule 103A.

Maple seeds 100A serve as a source of fascination for children every spring. As the seeds fall from the tree, they spin, causing them to flutter through the air. The seeds are eventually pulled to the ground through gravity, but not before the aerodynamic properties of the maple seed 100A have caused the seed to “fly” below the tree for a period of time.

During flight, the maple seed 100A float or naturally moves to a generally vertical position, with the seed nodule 103A being at the bottom, and the wing 101A extending upward. The maple seed 100A rotates rapidly about a vertical axis formed by the leading edge shaft 102A. As the wing 101A moves through the air, the seed 100A begins to slow in its descent, appearing to float.

FIG. 1B is an origami-formed version of a maple seed 100B which is intended to imitate or replicate the form and aerodynamic properties of a naturally occurring maple seed. The maple seed 100B includes a wing 101B and a shaft or fuselage 102B. The wing 101B and shaft 102B provide similar design construction to the natural maple seed 100A. There may be optional extra folding at the distal end of the shaft 102B (not shown) to add weight at the distal end and to further emulate the construction of the natural maple seed 100A.

It is proposed herein to construct a pet treat in the shape of the natural maple seed 100A using origami principles illustrated by the maple seed embodiment shown in FIG. 1B. The artificial maple seed 100B is formed from a planar sheet of light-weight, edible material. The artificial maple seed 100B has a center of gravity preferably somewhere within the wing 101B near the distal end of the shaft 102B. When the pet treat 100B falls, it rapidly rotates or spins, thereby producing a lift force based on the spin rate and speed of the wing and angle of attack through the air. The lift force results in a slower descent of the pet treat than otherwise without the spinning wing. A higher spin rate results in an increased lift force and flight time. Thus, the aerodynamic properties of the pet treat can be adjusted by changing the dimensions or weight distribution of the wing 101B.

In one aspect, a pet treat is formed in the approximate or general shape of a maple seed but with larger, proportional sizes. The ingredients of the planar material are edible and palatable to pet dogs and cats (individually) and may contain additives for flavor, health, color, texture and nutrition. The pet treat is designed and formulated to be manufactured in high volume and at low cost.

The pet treats of the present invention can be produced from standard pet treat ingredients. The pet treats may be gelatin based, protein based or plant based. An edible coating acting as an adhesive or decoration may be sprayed or rubbed onto portions of the pet treat.

In one aspect, the pet treats will include a meat ingredients such as chicken, liver, beef, venison, turkey or salmon. The treats may also include a baking flour such as wheat, rice or barley. In one aspect, the pet treats include dried fruits or vegetables. Finally, peanut butter is a pet treat ingredient that most dogs enjoy.

The treats may be rolled to a constant thickness or a variable patterned thickness, pressed, extruded, die cut, or otherwise formed to generate an ultimate aerodynamic shape. After being formed, the pet treats may be baked, microwaved, grilled, air-dried, sun baked, sun dried, or otherwise cooked, solidified, held into position to shape of the treat while reducing the weight and water content to optimize the aerodynamics of the treat.

In one aspect, the treats are fabricated into planar sheets from edible ingredients that allow for folding at the factory or by the pet owner. Instructions for folding a variety of shapes may be provided, stenciled or perforated on the treat-stock itself in the style of origami creations. Liquid coating such as water or a viscous liquid mixture may be optionally used as an edible adhesive to assist with holding the treat material together during construction, baking or drying.

FIG. 2A is a pet treat in the form of an origami-formed object 200A having an aerodynamic shape consisting of two oppositely disposed wings (or paired appendages). This object is also designed to rotate rapidly when falling based on the use of a plurality of wings 201 and 202 and an aerodynamic downward oriented nose cone 203 followed by a spiral shaped fuselage 204. This aerodynamically enhanced pet treat 200A rotates while falling, thereby producing lift forces based on the angles of the wings 201 and 202 as it descends. The center of gravity of the object 200A is preferably somewhere within the fuselage 204. The lift force results in a slower descent than otherwise without aerodynamic appendages that spin. A higher spin rate results in an increased lift force and flight time. Preferably, the pet treat formed in the shape of object 200A is light enough to also be affected by wind currents in an outdoor environment.

FIG. 2B is a pet treat in the form of an origami-shaped object 200B also having an aerodynamic shape. Here, the object 200B takes the shape of an airplane with two oppositely disposed wings. This object's shape allows it to glide when pushed through the air by an individual or mechanical device. This is another example of a shape that may be provided for a pet treat created from an edible pet treat material.

FIG. 4 is a pet treat 400 in in the form of an object that is designed to levitate, float, or slowly fall, when launched or flicked off of an elevated surface. This is another example of a shape that may be provided for a pet treat or created from an edible pet treat material. The pet treat defines a thin, curved rectangular shape. The treat is extremely light-weight, and will rotate or flutter when dropped. The object 400 in the shape of a “stick” of chewing gum, which weighs less than 5.0 grams, but having eccentric wings. Such an object will rotate rapidly about a vertical axis as it falls, creating a random flight path to the ground.

In still another embodiment, a planar pet treat material is provided along with a forming mold. The mold enables the owner to quickly form or cut the material into an aerodynamic shape, such as the eccentric shape of FIG. 4. In this embodiment, the planar material is extremely thin, being perhaps only 2 to 10 mm in thickness.

In one embodiment, the pet owner acquires pet treat material that is pre-fabricated in a planar shape to form a pet treat. The pet owner then goes through a folding or origami-forming process of folding the planar material in order to shape the treat into an object having enhanced aerodynamic properties. The pet treat may take on the profile of the maple seed 100B, the rotating object 200A, or an airplane 200B.

In another embodiment, the pet owner forms a pet treat through the use of a sheet of planar material. The pet owner then goes through a forming process of pressing the planar material against a three-dimensional form or mold such as a hemispherical, semi-ellipsoid, or rectangular mold. The pet owner trims the overlapped material at the edges of the mold to produce a hollow shell having two halves.

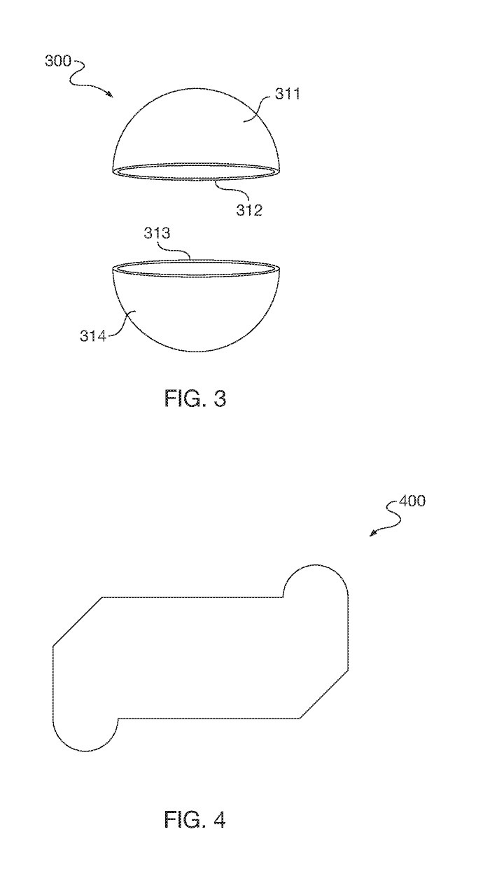

Referring to FIG. 3, a pet owner has formed and trimmed hemispherical edges 212 and 213 resulting in two hollow hemispherical shells 211 and 214. The hemispherical shell 211 and 214 are then attached by pressing the opposing edges 212 and 213 together optionally by applying an edible solvent or mixture, for example; water, acting as a glue to adhere the edges to each other before or after they are pressed to form a joined and hollow spherical shell 300.

The pet owner may optionally load smaller edible treats into one or more of the shell halves 211, 214 prior to being adjoined. Loaded enclosed shells result in a pet treats that rattles when shaken, thrown, dropped, or flung, or when released from a pet treat dispensing mechanism. This also results in the treat having an offset weight which causes the treat to wobble when rolled upon a surface such as a floor. In one aspect, the shell 300 is dimensioned to house the maple seed 100B, the rotating object 200A or the airplane 200B.

Other enclosed pet treat shell shapes, such as an oblong football shape or a random profile, create interest after the outer surface of the shell strikes the ground or a lower surface. Upon first striking any surface, the oblong or randomly shaped outer surface causes the pet treat to bounce erratically or to wobble. The shell may be edible, and may contain smaller pet treats that rattle during erratic flight paths and during bounces or rolls, thus adding entertainment value. The profile of the pet treat provides a randomness and/or uniqueness to its motion. In one aspect, the shell includes wings that add air resistance as the treat falls to the ground.

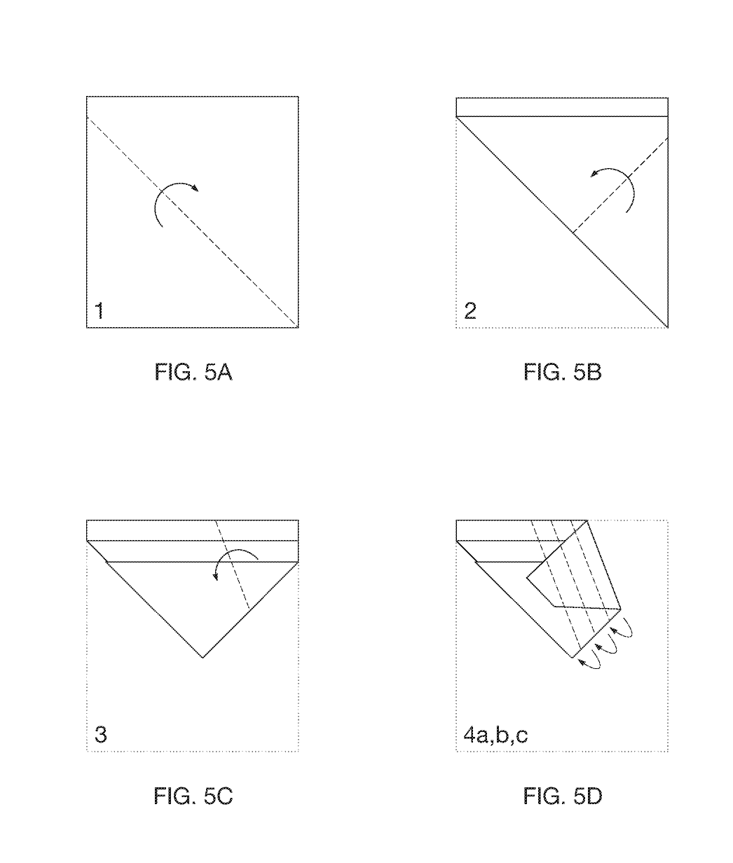

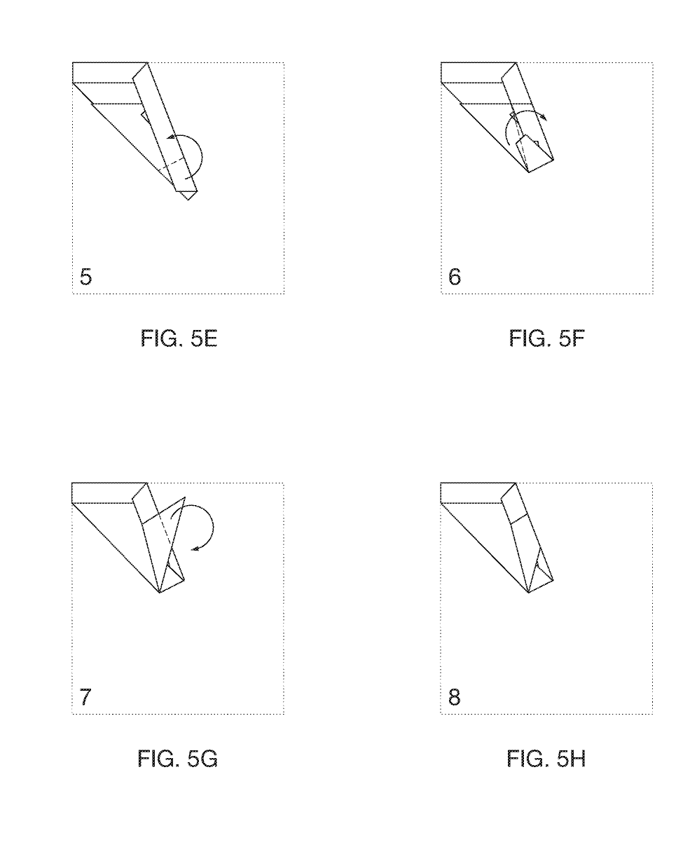

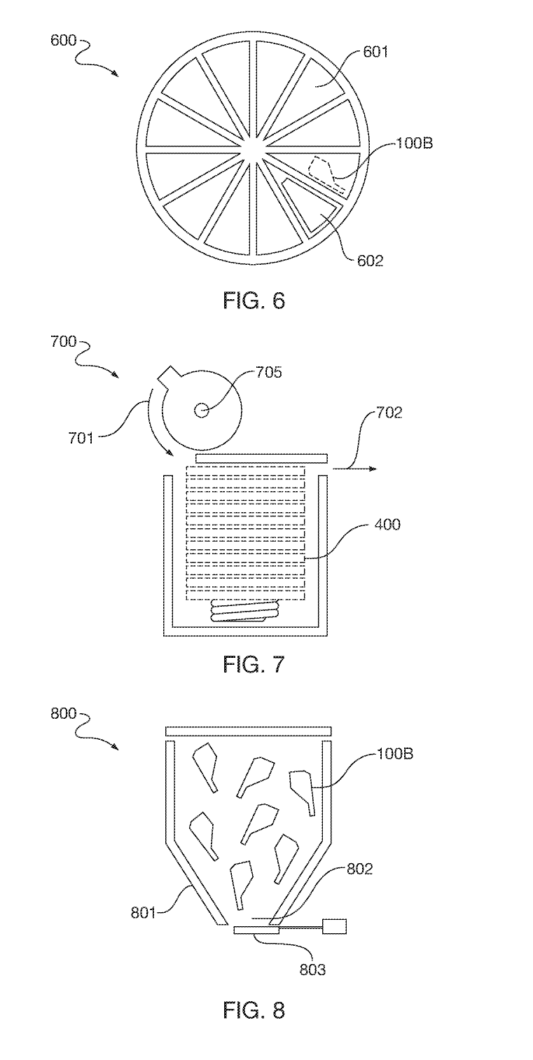

FIGS. 5A through 5H present a series of known steps used for folding paper into a maple seed configuration. The steps are numbered as 1 through 8. The illustrative steps are taken from the website http://www.cs.indiana.edu/˜jwmills/EDUCATION.NOTEBOOK/origami/origami.html. Folding lines in each step shown in FIGS. 1 through 8 are shown in broken lines.

In one aspect of the present invention, pet treat base material is extruded into sheets and sold in separated layers. The layers may be separated during packaging, for example, through the use of wax paper. Instructions are provided on, in or with the product packaging to inform the purchaser or the pet owner how to fold the pet treat material into an aerodynamic profile, such as the maple seed of FIG. 5H. The shape, weight and physical properties of the treat allow the treat to glide, float in the air, spin and/or sail upon descent.

A delivery mechanism specially designed to dispense pet treats is also provided herein. The delivery mechanism consists of a means for holding the treats and dispensing them individually (or in groups) according to their shape and aerodynamic properties.

For example, with pet treat shapes that are biased for flight, the delivery mechanism holds the treats in the proper orientation and propels or flings them into the air at the correct velocity, orientation, angle to the ground, and optional spin that provides a desired flight path. With treats that are designed to drop to generate their own aerodynamics through gravitational descent and air resistance, a simple “trap door” may suffice as a mechanical release mechanism.

With reference to FIG. 6, there is shown a schematic view of a portion of a dispensing mechanism 600, in one embodiment. Here, the dispensing mechanism 600 is in the form of a housing and a rotating carousel 601. The carousel rotates pet treats 100B to a release position 602 in the form of an opening. Release position 602 may represent a through-opening to a chute that allows the treat 100B to gravitationally fall to a lower surface.

This dispensing mechanism 600 is useful for dispensing hollow or enclosed pet treats 100B. The carousel 601 includes ribs which form individual chambers for holding one or more pet treats 100B within each chamber.

FIG. 7 is a schematic view of a portion of a dispensing mechanism 700, in another embodiment. Here, the pet treat dispensing mechanism 700 uses a motor arm 705 or wheel and cam 701 for releasing a pet treat 400 at a release position 702. With pet treats that are thin and approximately flat with a rectangular or round shape, a cam-leaver system that “deals” out the treats is useful. Alternatively, thin and approximately flat treats may be released with or without a spin using a fling release mechanism including a spring loaded, spinning, or centrifugal release motion.

FIG. 8 is a schematic view of a portion of a dispensing mechanism 800 in yet another embodiment. Here, the dispensing mechanism 800 is in the form of a housing a lower portion of which includes a funnel. In this embodiment, gravity acts upon individual pet treats 100B to urge them downwardly towards a release position in the form of a bottom opening. The dispensing mechanism 800 may optionally include a chute which transitions between the funnel 801 to a release position 802. A release mechanism 803 releases the pet treat 100B from a bottom opening when actuated. It is observed that this dispensing mechanism 800 may, in one embodiment, be similar in operation to a conventionally known gum ball dispenser.

In any of these embodiments, a pet treat dispensing system includes a dispensing mechanism, a release mechanism with either or both of a local mechanical release or an automated release under the control of a control unit. The pet treat dispensing system further or optionally includes a communications unit for communicating to a personal computer or smart device application, a motion sensor, a fan unit, and a control unit.

The dispensing mechanisms 600, 700, 800 may be battery operated. Alternatively, they may be solar powered through the use of photovoltaic cells. Most preferably, the dispensing mechanisms are configured to receive electricity through a conventional ac power line with a wall adapter.

Each of the dispensing mechanisms 600, 700, 800 also includes a housing and a lid. The housing and lid may be fabricated from metal, plastic or other material. Preferably, a transparent or translucent polycarbonate material is used which allows one to view the supply of pet treats remaining in the dispensing mechanism. The lid will provide at least a partial seal, to preserve the freshness of the pet treats and to prevent pet access.

In one aspect, the automated pet treat dispensing mechanism, in whatever embodiment, has a control panel. The control panel may offer local operation capability for actuating the pet treat dispenser using pushbutton actuated solenoid or a mechanical handle and valve release. Alternatively, the control panel includes an electronic display or touch screen and switches for programming and various operational indications. In this embodiment, the control unit preferably includes an LCD display or a “touch screen” that allows for timer-based control.

The dispensing mechanisms 600, 700, 800 may be positioned on a table top, elevated platform, or floor. Alternatively, the dispensing mechanisms 600, 700, 800 may be mounted to a wall, door or ceiling mounted.

In one aspect, a dispensing system 600, 700, 800 may be optionally operated on an event based process for use outside the presence of a pet owner. In this mode of operation, the manufacturer or the operator may program the dispensing system to dispense pet treats in response to an event, such as motion detection or bark detection. The pet treat dispensing system 600, 700, 800 may be equipped with a home/away mode control switch or setting so that the unattended or programmed automated dispensing mode is enabled only when the user is away, or may be programmed to operate automatically only during select week days or time periods.

The dispensing mechanism preferably includes a micro-processor which resides on a printed circuit board. In one embodiment, the micro-processor is in wireless electrical communication with a remotely operated control unit, or “remote control” through an associated receiver (or transceiver). The control unit enables the user to program and remotely control treat delivery cycles and options for treat delivery. In this arrangement, the control unit is a dedicated remote control that operates in proximity to the system through the use of IR or other wireless signals. This may be in addition to, or as an alternative to, the control panel.

In another aspect, the control unit represents a so-called tablet that communicates with the transceiver associated with the micro-processor of the dispensing mechanism. Communication is through a wireless protocol such as Bluetooth, Zigbee, Wi-Fi, or a telecommunications network. Alternatively, the control unit may be a general purpose computer that communicates with the transceiver associated with the micro-processor of the dispensing mechanism through a telecommunications network. In either instance, programming of the dispensing mechanism micro-processor may be done remotely.

Programming of the automated pet treat dispensing system 600, 700, 800 may be through software or firmware, referred to as “default settings,” as a factory default program that provides basic treat dispensing characteristics or selections. Such selections may include dispensing times, dispensing frequencies, or event based dispensing such as in response to motion detection, bark inputs, or audible alerts.

In remote or remotely controlled mode, the dispensing system may communicate back to the user through a remote device such as a personal computer over the internet or a smart device (such as an Apple iPhone® or Samsung Galaxy® or Apple iPad®) application. For example, the pet treat dispensing system may optionally report the number of pet treats remaining in its hopper or storage facility to the remote devices. The pet treat dispensing system's communication unit, or transceiver, may also communicate with text messages to and from the smart phone. One optional text communication aspect of the pet treat dispensing system is to send a text message warning to the user when the supply of pet treats in the hopper or storage facility becomes lower than approximately 25 percent, and optionally, an additional alarm message is sent to the user when the supply of pet treats in the hopper or storage facility becomes empty.

The optional post-programming, by the user, of an automated treat dispensing mechanism may be established through a selection process of some finite number of dispensing characteristics or parameters using radio pushbuttons or by selecting from a list on a display or touch screen or by rotating one or more selector switches and pressing buttons, resulting in changes to the default settings associated with dispensing characteristics or parameters.

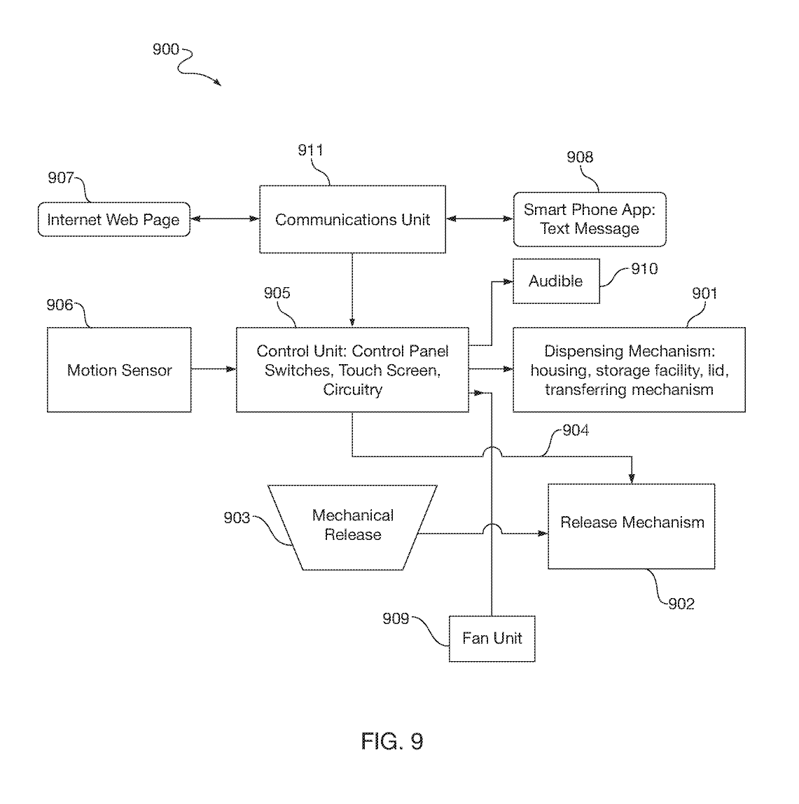

In one aspect, prior to an automated dispensing action or pet treat launch, an optional pre-dispensing alert audible (shown at speaker 910 in FIG. 9) is sounded, for an exemplary 1.5 seconds, to get the pet's attention. This allows the pet time to move to a closer location relative to the dispenser and for the pet to anticipate the dispensing action or launch of the pet treat. The audible alerts are selectable from a list as being any one of several types of sounds including but not limited to 1 kHz tone pulse, a bark, a meow, a pre-recoded command by the user, a jingle, a sound downloadable from a smart phone application or app, or ultrasonic signal (detectible by the pet only) sound.

Regarding programming bark and motion pet treat dispensing the system may include conventional programming; a zero (0) entry or selection may indicate that no input is available for that (motion or bark) function. A two (2) selection would require two inputs within a prescribed time to trigger or actuate the treat dispenser. The display screen or control panel may also include icons may be used on a control panel to select event actuation.

Once programmed, selected or enabled pet motion and bark event dispensing actuations proceed, and a maximum dispensing limit setting limits the number of actuations of the treat dispenser as allowed for a given active treat dispensing period. This dispensing limitation protects the pet from over indulging and the dispenser from becoming empty too soon.

A pet treat dispensing programming example is as follows;

| Parameter name | Selection | Description |
|---|---|---|
| Bark Detection | 2 | Two barks in succession activates the |
| | | dispenser |
| Bark Detection | 0 | No bark detection |
| Bark Detection | 1 | A single bark activates the dispenser |
| Motion Detection | 0 | No input |
| Motion Detection | 1 | Motion detection activates the treat |
| | | dispenser |
| Dispensing Limit | 5 | Number of automated dispenses per hour |
| Dispensing Limit | 0 | No frequency-based dispensing |
| Dispensing Limit | 1 | One treat dispensed per hour |
| Dispensing Limit | 2 | Two treats dispensed per hour, etc. |
| Home/Away | 0 | Home |
| Home/Away | 1 | Away |
| Audible | 0 | Ultrasonic (only pet hears it) |
| Audible | 1 | 1 kHz tone pulse |
| Audible | 2 | Bark |
| Audible | 3 | Meow |
| Audible | 4 | Pre-Recorded Command |
| Audible | 5 | Jingle |
| Audible | 6 | Downloaded sound (smart device app) |
| Fan Unavailable | 0 | Fan disabled, or no fan unit is installed |
| Fan Enable | 1 | Fan unit enabled |

A pet treat dispensing system 900 is presented schematically in FIG. 9. The dispensing system first includes a dispensing mechanism 901. The dispensing mechanism 901 may be in accordance with any of the embodiments 600, 700, 800 described above. The dispensing mechanism 901 is designed to selectively dispense pet treats in such a manner that an aerodynamic property of the pet treats enables them to glide or float to the ground upon release.

The dispensing system 900 also includes a release mechanism 902. The release mechanism 902 may be either or both of a local mechanical release 903 or an automated release 904. A speaker 910 under the control of an optional control unit 905 (if present) or control panel may be provided. The speaker 910 provides an audible alert.

The pet treat dispensing system 900 optionally includes a communications unit 911 for communicating to a personal computer over the internet 907 or smart phone (or other portable communications device) application 908. The communications unit 911 interacts with a micro-processor for messaging/alert service or for receiving control signals and program settings. The optional control unit 905 further includes a control panel, switches, a touch screen, and circuitry.

An optional motion sensor 906, and an optional fan unit 909 may also be included. The fan unit 909 includes a fan which is actuated when a pet treat is dispensed. The fan unit 909 causes air currents to act against the pet treat during its descent, thereby enhancing the aerodynamic action of the pet treat. The fan unit 909 may be mechanically detachable from the housing of the dispensing mechanism 901 with a tethered control or power cable remaining attached so that the fan unit 909 can be moved and relocated relative to the release mechanism 902. This further achieves the desired effect related to the aerodynamic behavior of the pet treats after release or launch.

In operation, at the time an audible pre-dispensing alert of the speaker 910 occurs, the fan unit 909 activates and delivers an airstream or air flow upwardly from the fan unit 909 in the vicinity of the pet treat as the pet treat exits the release mechanism. This air flow interaction with a pet treat results in varying aerodynamic behavior of the pet treat, including an extended levitation, levitation with wobbling, a temporary lift and deflection resulting in various extended flight paths and in-flight behavior of the pet treat. Additional results of the fan unit effects upon pet treats may be extended flight time, extended flight distance, higher pet treat elevations than the pet treat exit location, and in-flight erratic behavior, all of which adds to the entertainment value of the pet treat dispensing system as perceived by the pet and the pet owner. The fan unit 909 automatically powers off after a set time limit. For example, the fan unit 909 may power off after three seconds from the time it was powered up prior to the pet treat release.

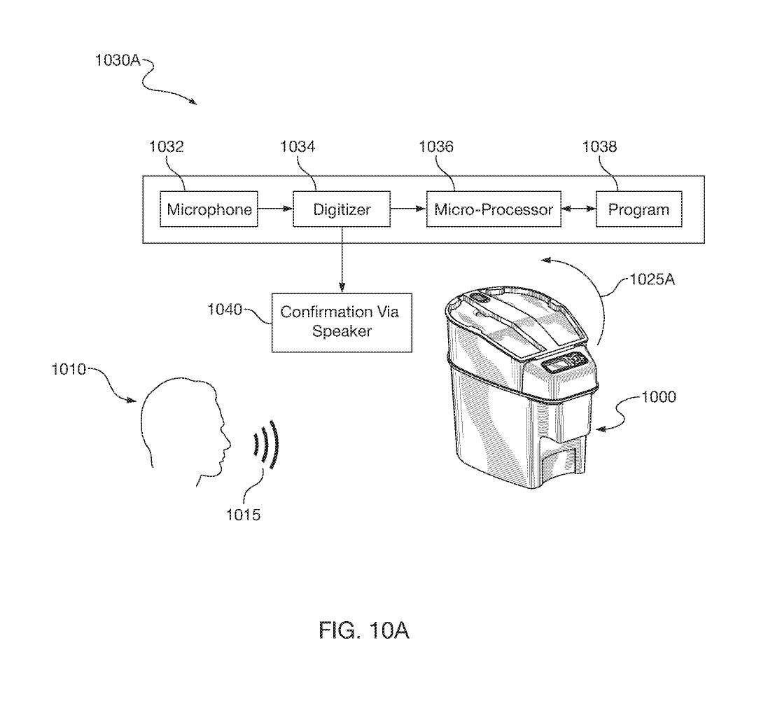

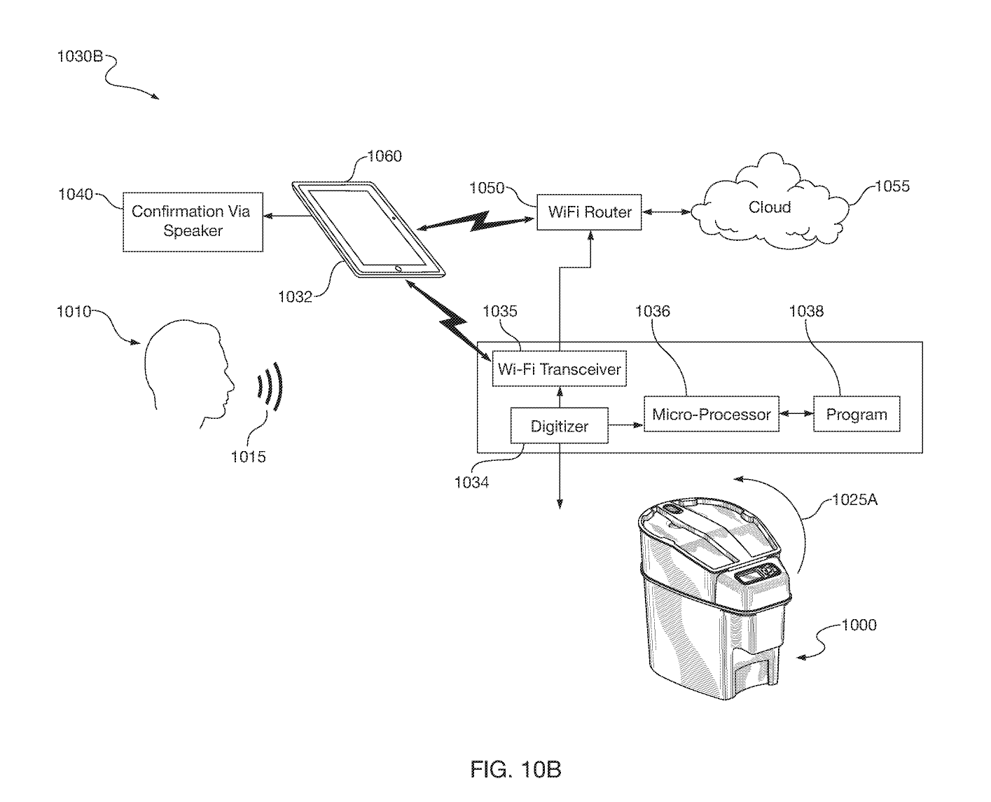

As noted above, the control unit 905 may optionally be programmed using voice recognition technology. FIGS. 10A and 10B demonstrate an illustrative treat dispensing mechanism 1000 that may be programmed using voice recognition technology. In each of FIGS. 10A and 10B, a user 1010 is shown providing voice commands 1015.

In FIG. 10A, the dispensing mechanism 1000 includes components 1030A which represent a control unit used to enable speech recognition. The components 1030A include a microphone 1032 designed to pick up sounds within the human or animal voice frequency range and transmit signals, typically as analog sounds signals. The components 1030A also include a digitizer 1034. The digitizer 1034 is typically be an analog-to-digital converter. The components 1030A also include a micro-processor 1036 and operational software, or programming 1038.

In the embodiment of FIG. 10A, the microphone 1032 resides on the dispensing mechanism 1000, such as part of the control unit 1030A. The user 1010 may speak commands 1015 into the microphone 1032 associated with the control unit 1030 on the mechanism 1000 itself. Commands 1015 are given “in person” in response to prompts, or queries, announced via speaker 1040. The treat dispensing mechanism 1000 employs dedicated hardware, software and memory to detect speech, decode the speech, program the unit 1000 and confirm the programming.

It is desirable to enable a programmable treat dispensing mechanism to receive speech commands 1015 remotely. In this way, the pet owner 1010 can deliver a pet treat while away from home, such as from his or her office.

FIG. 10B offers a variation of the device 1000 of FIG. 10A. In this arrangement, the treat dispensing mechanism 1000 is programmed by a pet owner 1010 speaking into a microphone 1032 associated with a personal handheld computer 1060, or “PDA” for a conversational programming process. Operational software, or an “App,” resides on the PDA 1060 to facilitate the conversation. This enables remote programming through voice recognition technology.

FIG. 10B again shows a user 1010 providing speech commands 1015. In this instance, the microphone 1032 resides on the PDA 1060. The PDA 1060, in turn, interfaces with a control unit 1030B to deliver programming queries back to the treat dispensing mechanism 1000.

Arrow 1025B demonstrates a control unit 1030B used to enable speech recognition. The components of the control unit 1030B again include a digitizer 1034 such as an analog-to-digital converter, a micro-processor 1036 and operational software, or programming 1038. However, in this embodiment the components 1030B further include a transmitter 1035 such as a Wi-Fi transmitter/receiver to transmit and receive wireless signals.

In operation, the user 1010 initiates the programming process by accessing an application associated with a personal handheld computer 1060, or “PDA.” Preferably, the PDA 1060 represents a so-called tablet or “2-in-1” that communicates with a transceiver associated with a digitizer and a micro-processor. Communication may be, for example, through Bluetooth (including Low Energy Bluetooth), IR, Zigbee or Wi-Fi, though preferably communication is through a wireless telecommunications network.

Examples of a suitable tablet include, but are not limited to, the iPad® available from Apple, Inc. of Cupertino, Calif., the Google® Nexus tablet provided by Google Inc. of Mountain View, Calif., the Samsung® Galaxy tablet of Samsung Electronics Co., Ltd. of the Republic of Korea, the Amazon® Kindle Fire tablet from Amazon Technologies Inc. of Seattle, Wash., the Lenovo® ThinkPad tablet of Lenovo Limited from Beijing, China, and the Microsoft® Surface tablet available from Microsoft Corporation of Redmond, Wash.

Alternatively, the PDA 1060 may be a so-called smart phone. Examples of a smart phone include, but are not limited to, the iPhone® from Apple, Inc., the Samsung® Galaxy, and the Droid RAZR® provided by Motorola, Inc. of Schaumburg, Ill. (It is acknowledged that Motorola, Inc. (or its telecommunications-related assets) may now be owned by Google, Inc. and that trademarks are likely owned by a trademark (or other IP) holding company out of Mountain View, Calif.)

In any arrangement, the personal handheld computer 1060 passes speech commands 1015 to the Cloud 1055 for decoding. The decoded speech returns to the PDA 1060, and the PDA 1060 then passes the programming commands to the programmable dispensing mechanism 1000. A Wi-Fi transmitter 1035 and Wi-Fi router 1050 are used to communicate data between the micro-processor 1036 and the Cloud 1055. Confirmation of the speech commands 1015 is provided by the micro-processor 1036 through the speaker 1040.

Other embodiments for remote programming may be used. In one arrangement, the PDA 1160 passes speech commands 1015 to the Cloud 1055, which then communicates the decoded programming commands 1015 directly to the programmable product 1000. In another aspect, the PDA 1160 receives speech commands 1015 from the user 1010 and then decodes the speech commands 1015 itself through the micro-processor 1036 and the operational software 1038. In another aspect, the user 1010 provides speech commands 1015 to the PDA 1060, which then transmits them directly to the programmable mechanism 1000 via a wireless communications network. The mechanism then sends the data to the Cloud 1055 for decoding. The decoded programming commands are then returned from the Cloud 1055 back to the programmable treat dispensing mechanism 1000.

The arrangements described herein provide a programming experience for the customer. The speech program steers the programming sequence and suggests the proper syntax of the customer's responses. This provides for a logical, sequential and efficient programming experience with improved accuracy. As intended for programmable pet treat dispensers, the inventions address the frustration related to programming time, day, and amount for pet feeding applications. More advanced units may add individual pet feedings by pet and weekday/weekend selections.

A method for providing a treat is also disclosed herein. In accordance with the method, a pet owner receives or is otherwise provided with pet treat material in planar, or in substantially planar, form. In one aspect, the pet treat material is actually rolled or extruded by the pet owner into planar form from a mass of material. The pet owner then folds the pet treat material by following a series of folding steps. The end result is that a pet treat having aerodynamic properties is created. Alternatively, for making enclosed shells, the pet owner presses the material upon three-dimensional molds and trims the material at the edges forming three-dimensional shape half-sections which are adjoined at the edges, resulting in enclosed shell pet treats that may optionally be loaded with smaller pet treats.

In one embodiment, the pet owner manually flicks, drops or throws a pet treat in such a way that the pet treat levitates for a time, glides or floats before slowly landing on the ground. The pet treat has enhanced aerodynamic properties. This provides entertainment and interest for both the pet owner and his/her pet.

In one method herein, the pet owner may place the aerodynamic or enclosed pet treats into a programmable mechanical dispensing mechanism.

Variations of the pet treat, and of the methods for dispensing the pet treat herein, may fall within the spirit of the claims, below. It will be appreciated that the inventions are susceptible to modification, variation and change without departing from the spirit thereof.

1. A pet treat comprising:
an edible material fashioned into a multi-dimensional object, wherein:
the multi-dimensional object has at least one wing; and
the multi-dimensional object is configured to have an enhanced aerodynamic property.

2. The pet treat of claim 1, wherein the multi-dimensional object comprises a generally rectangular fuselage having a thickness that is less than 3 mm for facilitating rotation and fluttering of the pet treat during flight.

3. The pet treat of claim 1, wherein the pet treat weighs less than 5.0 grams.

4. The pet treat of claim 1, wherein the pet treat has an uneven weight distribution, is configured in an eccentric profile, or both for facilitating aerodynamic fluttering.

5. The pet treat of claim 1, wherein:
the multi-dimensional object comprises a planar, rectangular-shaped body; and
the at least one wing comprises two oppositely- and eccentrically-disposed wings which enable aerodynamic rotation and fluttering.

6. The pet treat of claim 1, wherein the multi-dimensional object is in the general shape of a maple seed for facilitating rotation and fluttering.

7. The pet treat of claim 1, wherein:
the multi-dimensional object is in the shape of an airplane; and
the at least one wing comprises two oppositely- and symmetrically-disposed wings for facilitating aerodynamic gliding.

8. The pet treat of claim 1, wherein the pet treat is aerodynamically configured to rotate and gravitationally move in a random pattern.

9. A method of providing a treat to a pet, comprising:
providing an edible pet treat material in a planar form; and
folding the edible pet treat material through a series of folding steps into a multi-dimensional object that has enhanced aerodynamic properties for flight.

10. The method of claim 9, wherein the multi-dimensional object has at least one wing.

11. The method of claim 10, wherein the multi-dimensional object comprises a generally rectangular fuselage having a thickness that is less than 3 mm for facilitating rotation and fluttering of the pet treat during flight.

12. The method of claim 10, wherein:
the pet treat weighs less than 5.0 grams; and
the pet treat has an uneven weight distribution, is configured in an eccentric profile, or both for facilitating aerodynamic fluttering.

13. The method of claim 10, wherein:
the multi-dimensional object comprises a planar, rectangular-shaped body; and
the at least one wing comprises two oppositely- and eccentrically-disposed appendages which enable aerodynamic rotation and fluttering.

14. The method of claim 10, wherein the multi-dimensional object is in the general shape of a maple seed for facilitating rotation and fluttering.

15. The method of claim 10, wherein:
the multi-dimensional object is in the shape of an airplane; and
the at least one wing comprises two oppositely- and symmetrically-disposed appendages for facilitating aerodynamic gliding.

16. The method of claim 10, wherein the pet treat is aerodynamically configured to rotate and gravitationally move in a random pattern.

17. The method of claim 10, further comprising:
mechanically launching the folded pet treat, thereby causing the pet treat to descend to the ground under the influence of the flight enhancing aerodynamic properties.

18. The method of claim 10, wherein the planar material is less than 5 mm in thickness.

19. The method of claim 10, wherein the at least one wing comprises two oppositely disposed wings.

20. A method of providing a treat to a pet, comprising:
providing an edible pet treat material;
providing a mold having a multi-dimensional form;
placing a portion of the pet treat material over the mold; and
molding the pet treat material into a form according to the mold.

21. The method of claim 20, wherein the molded pet treat material (i) is less than 5 mm in thickness, (ii) weighs less than 500 mg, or (iii) both.

22. The method of claim 20, wherein the molded pet treat material is in the shape of a half-shell.

23. The method of claim 22, wherein the molded pet treat material has enhanced aerodynamic properties for flight.

24. The method of claim 20, wherein:
the molded pet treat material is in the shape of a first half-shell and a second half shell, with each half-shell having an arcuate edge; and
the method further comprises:
placing a pet treat into one of the half-shells,
compressing the arcuate edges of the first and second half-shells together to form an enclosed three-dimensional body holding the pet treat.

25. A method for dispensing treats for a pet, comprising:
providing a plurality of pet treats, each of the pet treats being fabricated from an edible material that has been fashioned into a multi-dimensional object having enhanced aerodynamic properties for flight;
loading the plurality of pet treats into a dispensing mechanism; and
activating the dispensing mechanism to release one of the plurality of pet treats, thereby causing the pet treat to become airborne.

26. The method of claim 25, wherein the dispensing mechanism comprises:
a housing; and
a release mechanism that sequentially and individually releases the plurality of pet treats.

27. The method of claim 26, wherein:
the housing holds a carousel having a plurality of compartments, wherein each of the compartments holds one pet treat of the plurality of pet treats;
the dispensing mechanism comprises a platform over which the carousel rotates; and
the release mechanism comprises an opening in the carousel, wherein a pet treat falls through the opening when the opening aligns with a pet treat of the plurality of pet treats during rotation of the carousel.

28. The method of claim 26, wherein:
the housing holds the plurality of pet treats in stacked relation;
the dispensing mechanism comprises a base for supporting the stacked pet treats; and
the release mechanism comprises a rotating arm that imparts a force upon a pet treat of the plurality of pet treats causing the pet treat to be pushed away from the housing.

29. The method of claim 26, wherein the release mechanism is activated (i) in response to sensing motion, (ii) in response to sensing the bark of a canine, or (iii) in response to an electrical signal.

30. The method of claim 29, wherein:
the dispensing mechanism is programmed to release a pet treat on a periodic basis; and
the dispensing mechanism emits an audible signal within three seconds of activating the release mechanism.

31. The method of claim 30, further comprising:
programming the dispensing mechanism using voice recognition technology.

32. A pet treat dispensing system comprised of:
a dispensing mechanism comprising a housing, a storage area for storing a plurality of pet treats, and a transferring mechanism for transferring a pet treat to a release position;
a release mechanism wherein the pet treat is released from the dispensing mechanism at a position that enables the released pet treat to gravitationally fall to a floor surface; and
a control unit for controlling the dispensing mechanism; and
wherein the pet treats each have an enhanced aerodynamic property.

33. The pet treat dispensing system of claim 32, further comprising:
a communication unit for communicating with the control unit via wireless communication using a handheld personal computer.

34. The pet treat dispensing system of claim 33, wherein:
the control unit is a personal digital assistant having a transceiver; and
the transceiver in the personal digital assistant communicates with the communication unit via a telecommunications network, or via wireless signals according to RF, Zigbee, Wi-Fi, or Bluetooth protocol.

35. The pet treat dispensing unit of claim 33, wherein the communication unit:
transmits a storage facility low quantity warning to a remote control unit;
transmits a storage facility empty alarm warning to a remote control unit; and
receives a dispense command from the control unit and responds by dispensing a pet treat.

36. The pet treat dispensing system of claim 32, further comprising:
a motion sensor for sensing pet motion and providing a motion sensor input to the control unit.

37. The pet treat dispensing system of claim 32, wherein the control unit comprises:
a control algorithm using programmed selections to determine when to automatically dispense a pet treat;
a timer for actuating the dispensing mechanism in response to programming of the control algorithm; and
a control panel and control circuitry for processing and sending electrical signals between electronic components within the control unit.

38. The pet treat dispensing system of claim 37, further comprising:
a motion sensor for sensing pet motion and providing a motion sensor input to the control unit, and wherein the motion sensor input is used by the control algorithm in the control unit for actuating the dispensing mechanism.

39. The pet treat dispensing system of claim 37, further comprising:
a speaker, wherein
an audible alert is produced by the control algorithm in the control unit through the speaker for alerting the pet that a pet treat will be released, and
the pet treat is released from the release mechanism within three seconds after the audible alert.

40. The pet treat dispensing system of claim 32, further comprising:
a fan unit, wherein the fan unit is switched on by the control algorithm in the control unit to provide air flow in the flight path of the pet treat upon dispensing a treat.

41. A pet treat dispensing system comprising:
a housing dimensioned to hold a plurality of pet treats, each pet treat having at least one wing to impart an aerodynamic property;
a release mechanism coupled to the housing which releases a pet treat from the housing;
a microphone for receiving voice commands from a human user and delivering the voice commands as electrical signals for voice recognition processing, wherein the voice commands are in the form of instructions for dispensing a pet treat of the plurality of pet treats from the housing through actuation of the release mechanism; and
a micro-processor for processing digitized signals, and delivering responsive signals to the user as audible voice commands through a speaker.

42. The pet treat dispensing system of claim 41, further comprising:
a user control unit having an interface by which a user may alternatively manually program the pet treat dispensing system according to a schedule.

43. The pet treat dispensing system of claim 41, wherein:
the microphone resides adjacent the housing;
the system further comprises a digitizer for converting the electrical signals of the voice commands into a digital form; and
the micro-processor decodes the voice commands that are in digital form as the voice recognition processing.

44. The pet treat dispensing system of claim 41, wherein:
the microphone resides on a handheld personal computer;
the handheld personal computer transmits speech commands to a remote processor for decoding as part of the voice recognition processing; and
decoded speech returns to the handheld personal computer where the speech is received by a transceiver.

45. The pet treat dispensing system of claim 44, wherein:
the pet treat dispensing system further comprises a digitizer for converting the decoded speech of the voice commands into a digital form upon receipt by the transceiver; and
the transceiver is further configured to send wireless signals back to the handheld personal computer in the form of programming queries to be audibly delivered to the human user by the handheld personal computer.

46. The pet treat dispensing system of claim 44, wherein:
(a) the remote processor is a Cloud-based processor, and the handheld personal computer is configured to (i) deliver voice commands to the Cloud for decoding, (ii) receive the decoded signals from the Cloud, and then (iii) transmit the decoded signals to the transceiver for further processing; or
(b) the remote processor is a Cloud-based processor, and the handheld personal computer is configured to deliver voice commands to the Cloud for decoding, whereupon decoded speech signals are sent to the transceiver for further processing; or
(c) the personal digital assistant is configured to deliver voice commands directly to the transceiver for processing, wherein decoding of voice commands takes place within the micro-processor; or
(d) the personal digital assistant is configured to deliver voice commands directly to the transceiver for further processing, wherein the voice commands are sent to the Cloud for decoding, and the decoded voice commands are then returned to the transceiver for further processing.
